(19) United States
(12) Patent Application Publication
(10) Pub. No.: US 2026/0169469 A1
(43) Pub. Date: Jun. 18, 2026

(54) INDUSTRIAL BIG DATA-BASED METHOD AND SYSTEM FOR OPERATIONAL OPTIMIZATION OF COAL-FIRED POWER GENERATING UNIT

(71) Applicants: JIANGSU HANGUANG INTELLIGENT TECHNOLOGY CO., LTD., Xuzhou (CN); XIHUA UNIVERSITY, Chengdu (CN)

(72) Inventors: Yuanke ZHOU, Xuzhou (CN); Yuansi ZHOU, Xuzhou (CN); Huaichun ZHOU, Chengdu (CN)

(73) Assignees: JIANGSU HANGUANG INTELLIGENT TECHNOLOGY CO., LTD., Xuzhou (CN); XIHUA UNIVERSITY, Chengdu (CN)

(21) Appl. No.: 19/414,385

(22) Filed: Dec. 10, 2025

(30) Foreign Application Priority Data
Dec. 13, 2024 (CN) 202411844652.3

(51) Int. Cl. G05B 23/02

(52) U.S. Cl. CPC G05B 23/0224; G05B 23/0275

(57) ABSTRACT

The provided is an industrial big data-based method and system for operational optimization of a coal-fired power generating unit. A startup priority analysis module dynamically adjusts a unit startup sequence by analyzing a real-time dataset and a load demand of a power grid to acquire a unit startup priority. The system can quickly determine the unit startup sequence based on a value of the unit startup priority and effectively identify a unit with a potential fault risk. A fault identification module conducts fault evaluation on unit operation status data and equipment status data based on the real-time dataset and a historical dataset, and calculates a current fault evaluation index. Through comprehensive analysis of a historical trend and a real-time status, the system can accurately determine whether the unit needs to be maintained, thereby achieving early prediction and timely intervention of a potential fault.

### CROSS-REFERENCE TO THE RELATED APPLICATIONS

This application is based upon and claims priority to Chinese Patent Application No. 202411844652.3, filed on Dec. 13, 2024, the entire contents of which are incorporated herein by reference.

### TECHNICAL FIELD

The present disclosure relates to the field of industrial technology, and specifically, to an industrial big data-based method and system for operational optimization of a coal-fired power generating unit.

### BACKGROUND

The coal-fired power generating unit, as an important part of global electricity production, is widely used in the traditional energy field and serves as a core of stable operation of a power grid. With the continuous advancement of industrial technologies, industrial big data has become one of key technologies for driving energy management and optimization. Through real-time monitoring, data analysis, and intelligent optimization, new vitality is injected into the traditional energy industry. In the field of combining the industrial big data and the coal-fired power generating unit, intelligent operational optimization performed on a power generating unit based on massive real-time and historical data has become one of hotspots in academic research and industrial applications. Specifically, a startup-shutdown sequence and load distribution of coal-fired power generating units are optimized based on real-time load data of the power grid and operation statuses of the units. This can significantly improve a response capability of a power grid load, reduce energy consumption, and enhance economic performance of unit operation. This big data-based optimization technology effectively integrates data analysis and system scheduling, providing a solution for intelligent, green, and efficient coal-fired power generation.

In current operation management of a coal-fired power generating unit, a traditional startup-shutdown sequence and a traditional load distribution strategy often rely on manual experience or simple rules, lacking a capability of dynamic adjustment based on real-time data. This management mode may lead to a response delay when a load demand fluctuates greatly, making it difficult to quickly allocate a resource to meet a power grid demand. In addition, due to a lack of in-depth analysis of historical operation data of a unit, economic performance and availability of the unit are difficult to be optimally guaranteed under a complex operation condition, resulting in excessive fuel consumption and reduced power generation efficiency. Especially for a potential unit fault, a traditional method relies on regular inspection or equipment alarming, making it difficult to conduct trend prediction and early intervention. This often leads to delayed equipment maintenance or over-maintenance. Therefore, a current system has significant deficiencies in optimization efficiency, the response capability of the power grid load, and a fault prediction capability, and an industrial big data-based intelligent optimization system is urgently required for improvement.

### SUMMARY

To address the deficiencies in the prior art, the present disclosure provides an industrial big data-based method and system for operational optimization of a coal-fired power generating unit, so as to solve the problems described in BACKGROUND.

In order to achieve the above objective, the present disclosure is implemented by using the following technical solutions: An industrial big data-based system for operational optimization of a coal-fired power generating unit includes a data acquisition module, a data processing module, a startup priority analysis module, a fault identification module, and an effect feedback and optimization module, where
the data acquisition module is configured to monitor, by using a plurality of monitoring instruments, relevant unit operation data and relevant equipment status data of each coal-fired power generating unit in real time, generate a real-time dataset, and acquire a historical dataset of each coal-fired power generating unit in a historical time period based on a big data technology;
the data processing module is configured to perform data preprocessing on relevant data in the real-time dataset, including denoising, outlier elimination, and missing value imputation, and construct a processed real-time dataset after dimensionless processing;
the startup priority analysis module is configured to analyze and determine a current startup sequence of each unit based on relevant unit operation data in the processed real-time dataset and a load demand Dfyq of a power grid, so as to acquire a unit startup priority Qyxj; determine, based on a value of the unit startup priority Qyxj, a startup sequence and whether there is a fault risk for each unit; and trigger a trend analysis instruction if there is a fault risk;
the fault identification module is configured to receive the trend analysis instruction, analyze a current fault evaluation index Ggzs_{c} of each unit during operation based on relevant equipment status data in the processed real-time dataset, and determine, based on the historical dataset, whether the corresponding unit needs to be maintained; and
the effect feedback and optimization module is configured to perform feedback based on an actual effect formed by the startup sequence of each unit, acquire relevant feedback data, evaluate a balance effect between a response capability of a power grid load and unit operation efficiency based on the relevant feedback data to construct a performance feedback index Xfzs, and adjust and optimize a load capacity of the corresponding unit based on the performance feedback index Xfzs.

Preferably, the data acquisition module includes a real-time monitoring unit and a historical extraction unit;
the real-time monitoring unit is configured to monitor, by using the plurality of monitoring instruments, the relevant unit operation data and the relevant equipment status data of each coal-fired power generating unit in real time, where the relevant unit operation data includes a fuel consumption Rxz per unit time, a load output value Fsz, an availability coefficient Kyz at each time point, a unit load fluctuation factor Fbyz, and a maximum target power generation load value Fbzₘₐₓ of each unit; the relevant equipment status data includes a boiler pressure fluctuation factor Ybyz₁ and a steam pipeline pressure fluctuation factor Ybyz₂; the plurality of monitoring instruments include a laser-type coal flow meter, a power monitoring instrument, and a unit performance testing instrument; and the real-time dataset includes the relevant unit operation data and the relevant equipment status data; and
the historical extraction unit is configured to acquire, by using the big data technology, relevant unit operation data and relevant equipment status data of each coal-fired power generating unit in an industrial park in the historical time period, and the historical dataset includes the relevant unit operation data and the relevant equipment status data in the historical time period.

Preferably, the data processing module includes a preprocessing unit and a normalization unit;
the preprocessing unit is configured to perform preprocessing on the relevant data in the real-time dataset, where the preprocessing includes the denoising, the missing value imputation, the outlier elimination, and data smoothing, and methods for the missing value imputation include mean imputation, median imputation, interpolation imputation, and regression imputation; and
the normalization unit is configured to eliminate, by using a dimensionless processing technology, a unit difference of relevant data in the preprocessed real-time dataset, such that a range of the relevant data in the preprocessed real-time dataset falls within [0, 1].

Preferably, the startup priority analysis module includes an operation status analysis unit, a priority unit, and a preliminary determination unit;
the operation status analysis unit is configured to extract the fuel consumption Rxz per unit time and the load output value Fsz of each unit from the relevant unit operation data in the processed real-time dataset, and calculate an economic index Jzb of each unit based on the fuel consumption Rxz per unit time and the load output value Fsz of each unit, where the economic index Jzb of each unit is specifically acquired according to a following formula:

$$Jzb = \frac{R x z}{F s z} ;$$

and

calculate a target power generation load value Fbz of each unit in different monitoring time periods based on the economic index Jzb of each unit and the load demand Dfyq of the power grid, where the target power generation load value Fbz of each unit in the different monitoring time periods is specifically acquired according to a following formula:

$$Fbz = \frac{Dfyq ( t ) * {Jzb}^{- 1}}{{\sum }_{i = 1}^{n} {Jzb}^{- 1}}$$

where in the above formula, Fbz(t) represents a target power generation load value of the corresponding unit at a time point t, Dfyq(t) represents a load demand of the power grid at the time point t, Jzb⁻¹ represents an economic weight of the corresponding unit, n represents a quantity of units, and i=1, 2, 3, . . . , n.

Preferably, the priority unit is configured to analyze and determine the current startup sequence of each unit based on the relevant unit operation data in the processed real-time dataset and a current load demand of the power grid, so as to acquire the unit startup priority Qyxj, where the unit startup priority Qyxj is specifically acquired according to a following formula:

$$Qyxj ( t ) = \frac{{Jzb}^{- 1} * Kyz ( t ) * {Fbz}_{max}}{Fbz ( t ) + ∈}$$

where in the above formula, Qyxj(t) represents a unit startup priority of the corresponding unit at the time point t, Kyz(t) represents an availability coefficient of the corresponding unit at the time point t, Fbzₘₐₓ represents the maximum target power generation load value of the corresponding unit, and E represents a correction constant.

Preferably, the preliminary determination unit is configured to separately acquire the unit startup priority Qyxj for each unit according to a method of acquiring the unit startup priority Qyxj in the priority unit, and perform sorting to generate a sequence group; determine the unit startup priority Qyxj for the corresponding unit in the historical time period based on the historical dataset, and acquire an average unit startup priority Qyxj_{avg} of the corresponding unit by combining a statistical mean algorithm; and compare the unit startup priority Qyxj of a current unit with the average unit startup priority Qyxj_{avg} of the corresponding unit to determine a startup sequence and whether there is a fault risk for the corresponding unit, where preliminary determination content is specifically as follows:
if the unit startup priority Qyxj for the current unit is greater than or equal to the average unit startup priority Qyxj_{avg} of the corresponding unit, preliminarily determining that there is no fault risk in the corresponding unit currently, such that the trend analysis instruction is not triggered temporarily, the corresponding unit is retained in the sequence group, and the corresponding unit is marked as a normal unit; or
if the unit startup priority Qyxj for the current unit is less than the average unit startup priority Qyxj_{avg} of the corresponding unit, preliminarily determining that there is a fault risk in the corresponding unit, such that the trend analysis instruction is triggered, the corresponding unit is removed from the sequence group, and the corresponding unit is marked as an abnormal unit; and
count the normal unit based on the preliminary determination content, perform re-sorting to generate an optimized sequence group, and determine a startup sequence of each normal unit based on the optimized sequence group.

Preferably, the fault identification module includes a fault analysis unit and an identification unit;
the fault analysis unit is configured to, after receiving the trend analysis instruction, analyze the current fault evaluation index Ggzs_{c} of each current abnormal unit during the operation based on the relevant equipment status data in the processed real-time dataset after the dimensionless processing, where the current fault evaluation index Ggzs_{c} is acquired according to a following formula:

$$G g z {s}_{c} = \frac{Δ Qyxj * α + {Ybyz}_{1} * β + {Ybyz}_{2} * γ + Fbyz * φ}{α + β + γ + φ}$$

where in the above formula, ΔQyxj represents a unit startup priority difference, Ybyz₁ represents the boiler pressure fluctuation factor, Ybyz₂ represents the steam pipeline pressure fluctuation factor, Fbyz represents the unit load fluctuation factor, and α, β, γ, and φ all represent weight values, where 0<α<1, 0<β<1, 0<γ<1, 0<φ<1, and specific values of the α, the β, the γ, and the φ are set by a user based on a situation; and
the identification unit is configured to determine a time point when a current corresponding abnormal unit is last marked as an abnormal unit to mark the time point as a start timestamp, and mark a current time point as an end timestamp; acquire a time interval based on the start timestamp and the end timestamp, and use the time interval as a comparison time period; extract a fault evaluation index Ggzsₕ at the start timestamp from the historical dataset based on the start timestamp; and compare the current fault evaluation index Ggzs_{c} of each unit during the operation with the fault evaluation index Ggzsₕ at the start timestamp to determine whether the corresponding abnormal unit needs to be maintained, where specific content is as follows:
if the current fault evaluation index Ggzs_{c} of each unit during the operation exceeds the fault evaluation index Ggzsₕ at the start timestamp, a maintenance instruction is issued, and maintenance personnel is arranged to perform on-site maintenance; or
if the current fault evaluation index Ggzs_{c} of each unit during the operation does not exceed the fault evaluation index Ggzsₕ at the start timestamp, no maintenance instruction is issued temporarily.

Preferably, the effect feedback and optimization module includes an effect feedback unit and an optimization unit;
the effect feedback unit is configured to: perform the feedback based on the actual effect formed by the startup sequence of each unit, and acquire the relevant feedback data, where the relevant feedback data includes a quantity m of normal units, a load output value of a corresponding normal unit at each time point, a target power generation load value of the corresponding normal unit at each time point, and a fuel consumption of the corresponding normal unit at each time point; and evaluate the balance effect between the response capability of the power grid load and the unit operation efficiency based on the relevant feedback data, and perform the dimensionless processing to construct the performance feedback index Xfzs, where the performance feedback index Xfzs is acquired according to a following formula:

$$Xfzs ( t ) = {\sum }_{k = 1}^{m} \vert {Fsz}_{k} ( t ) - {Fbz}_{k} ( t ) \vert + ω * {\sum }_{k = 1}^{m} ( \frac{{Rxz}_{k} ( t )}{{Fsz}_{k} ( t )} )$$

where in the above formula, k=1, 2, . . . , m, m represents the quantity of normal units, Xfzs(t) represents a performance feedback index at a time point t, FSZₖ(t) represents a load output value of a k^{th} normal unit at the time point t, Fbzₖ(t) represents a target power generation load value of the k^{th} normal unit at the time point t, RXZₖ(t) represents a fuel consumption of the k^{th} normal unit at the time point t, and w represents a weight coefficient.

Preferably, the optimization unit is configured to adjust and optimize the load capacity of the corresponding unit based on the performance feedback index Xfzs by using a gradient descent method, so as to acquire a load adjustment amount Ft of the corresponding unit at each subsequent time point:

$$Ft ( t ) = - η * \frac{ϑ Xfzs ( t )}{ϑ {Fsz}_{k} ( t )}$$

where in the above formula, Xfzs(t) represents the performance feedback index at the time point t, n represents a learning rate, and

$$\frac{ϑ Xfzs ( t )}{ϑ {Fsz}_{k} ( t )}$$

represents a partial derivative of the performance feedback index at the time point t with respect to the load output value of the unit at the time point t.

An industrial big data-based method for operational optimization of a coal-fired power generating unit includes following steps:
S1, monitoring, by using a plurality of monitoring instruments, relevant unit operation data and relevant equipment status data of each coal-fired power generating unit in real time, generating a real-time dataset, and acquiring a historical dataset of each coal-fired power generating unit in a historical time period based on a big data technology;
S2, performing data preprocessing on relevant data in the real-time dataset, including denoising, outlier elimination, and missing value imputation, and constructing a processed real-time dataset after dimensionless processing;
S3, analyzing and determining a current startup sequence of each unit based on relevant unit operation data in the processed real-time dataset and a load demand Dfyq of a power grid, so as to acquire a unit startup priority Qyxj; determining, based on value of the unit startup priority Qyxj, a startup sequence and whether there is a fault risk for each unit; and triggering a trend analysis instruction if there is a fault risk;
S4, receiving the trend analysis instruction, analyzing a current fault evaluation index Ggzs_{c} of each unit during operation based on relevant equipment status data in the processed real-time dataset, and determining, based on the historical dataset, whether the corresponding unit needs to be maintained; and
S5, performing feedback based on an actual effect formed by the startup sequence of each unit, acquiring relevant feedback data, evaluating a balance effect between a response capability of a power grid load and unit operation efficiency based on the relevant feedback data to construct a performance feedback index Xfzs, and adjusting and optimizing a load capacity of the corresponding unit based on the performance feedback index Xfzs.

The present disclosure provides an industrial big data-based method and system for operational optimization of a coal-fired power generating unit, and achieves the following benefits:
(1) Through a plurality of monitoring instruments in a data acquisition module, the system can acquire an operation status and equipment data of a unit in real time to form a real-time dataset, and analyze a long-term operation status of the unit based on a historical dataset and a big data technology to fully grasp an operation law and a load characteristic of the unit. Such a combination of real-time and historical data not only improves completeness of data analysis, but also provides reliable data support for accuracy of an optimization strategy in the future. A startup priority analysis module dynamically adjusts a unit startup sequence by analyzing the real-time dataset and a load demand of a power grid to obtain a unit startup priority. The system can quickly determine the unit startup sequence based on a value of the unit startup priority, effectively identify a unit with a potential fault risk, and further trigger a trend analysis instruction. While ensuring a response capability of a power grid load, the startup priority analysis module reduces blindness of a startup-shutdown decision and improves economic performance of unit operation. A fault identification module conducts fault evaluation on unit operation status data and equipment status data based on the real-time dataset and the historical dataset, and calculates a current fault evaluation index. Through comprehensive analysis of a historical trend and a real-time status, the system can accurately determine whether the unit needs to be maintained, thereby achieving early prediction and timely intervention of a potential fault. This function effectively reduces a risk of an unplanned shutdown of the unit and ensures operation stability of the system. An effect feedback and optimization module evaluates feedback data of an actual operation effect, and constructs a performance feedback index, thereby dynamically adjusting and optimizing unit load distribution. On this basis, the system can continuously optimize a balance between the response capability of the power grid load and unit operation efficiency, ensuring that the unit operates with a lowest fuel consumption while meeting a power grid demand. This closed-loop optimization mechanism enables the system to continuously adjust the optimization strategy based on an actual effect, thereby achieving continuous improvement of operation efficiency.
(2) A priority unit dynamically calculates a startup priority Qyxj of each unit by combining a unit operation status in the real-time dataset and the load demand of the power grid, and comprehensively considers an availability coefficient, a maximum target power generation load value, and a correction constant of the unit to ensure calculation accuracy and robustness. The startup priority analysis module can quickly adjust a unit startup-shutdown sequence based on a real-time load demand of the power grid, giving priority to starting a unit with high availability and a strong power generation capability, which effectively improves the response capability of the power grid load. This further avoids a waste of resources and a decline in economic performance due to operation of a low-priority unit. A preliminary determination unit calculates an average unit startup priority of each unit based on the historical dataset by using a statistical mean algorithm, and further compares and verifies a currently calculated unit startup priority Qyxj. If the current priority Qyxj is lower than a historical average value, the system can preliminarily determine that a corresponding unit has a fault risk, promptly trigger the trend analysis instruction, and eliminate a possible unit with a fault from a sequence group. By dynamically comparing historical and current data, this mechanism accurately identifies a potential fault, improves efficiency of fault detection, prevents a faulty unit from participating in operation of the power grid, and ensures system stability. After sorting the unit startup priority Qyxj, the preliminary determination unit generates the sequence group, eliminates a potential faulty unit, optimizes a unit sequence, and re-determines a startup sequence of a normal unit based on an optimized sequence group to ensure that the system preferentially starts a unit with a good operation status and a strong power generation capability.
(3) After receiving the trend analysis instruction, a fault analysis unit combines relevant equipment status data in the processed real-time dataset and calculates a fault evaluation index of each abnormal unit after dimensionless processing. Through accurate calculation of the fault evaluation index, the system can multi-dimensionally quantify an abnormity degree of the unit operation, significantly improving accuracy of the fault evaluation and providing a scientific basis for subsequent fault identification and decision-making. An identification unit accurately records duration of an abnormal state by marking a start timestamp and an end timestamp of the abnormal unit, and dynamically analyzes a development trend of a fault by using a time interval as a comparison time period. A fault evaluation index at the start timestamp is extracted from the historical dataset and compared with the current fault evaluation index, such that the system can dynamically determine the severity and the development trend of the fault. If the current fault evaluation index exceeds the fault evaluation index at the start timestamp, it indicates that the fault is intensifying, and the system immediately triggers a maintenance instruction to arrange on-site maintenance to ensure timely handling of the fault. If the current fault evaluation index does not exceed a historical value, it indicates that the fault is under control, and the system does not issue a maintenance instruction temporarily, thereby avoiding an unnecessary maintenance operation and reducing a maintenance cost. Through linked analysis of the real-time and historical data, the fault identification module effectively avoids a waste of resources and fault escalation due to over-maintenance or delayed maintenance.
(4) The construction of the performance feedback index Xfzs realizes quantitative evaluation of the response capability of the power grid load and the unit operation efficiency by comprehensively analyzing a load error and fuel economy, greatly improving operability and evaluation accuracy of the system. Combined with a dynamic optimization unit based on a gradient descent method, the system can reduce an impact of a load fluctuation of the power grid on the unit operation through a scientific load distribution strategy, reduce fuel waste, and improve power generation efficiency.

### BRIEF DESCRIPTION OF THE DRAWINGS

FIG. 1 is a block diagram of an industrial big data-based system for operational optimization of a coal-fired power generating unit according to the present disclosure; and

FIG. 2 is a schematic flowchart of an industrial big data-based method for operational optimization of a coal-fired power generating unit according to the present disclosure.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely a part rather than all of the embodiments of the present disclosure. All other embodiments derived by those of ordinary skill in the art based on the embodiments of the present disclosure without creative efforts should fall within the protection scope of the present disclosure.

### Embodiment 1

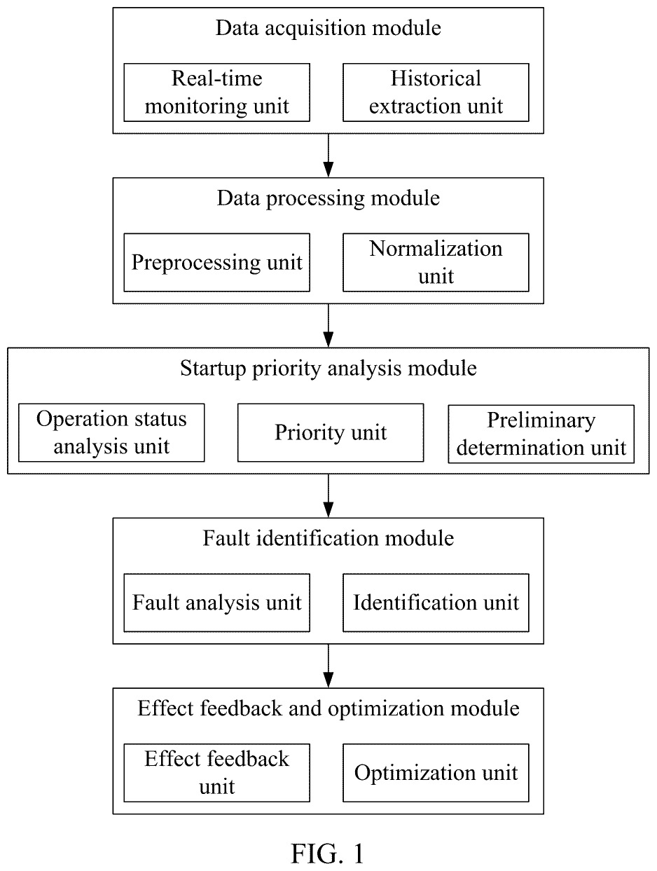

Referring to FIG. 1, the present disclosure provides an industrial big data-based system for operational optimization of a coal-fired power generating unit, including a data acquisition module, a data processing module, a startup priority analysis module, a fault identification module, and an effect feedback and optimization module.

The data acquisition module is configured to monitor, by using a plurality of monitoring instruments, relevant unit operation data and relevant equipment status data of each coal-fired power generating unit in real time, generate a real-time dataset, and acquire a historical dataset of each coal-fired power generating unit in a historical time period based on a big data technology.

The data processing module is configured to perform data preprocessing on relevant data in the real-time dataset, including denoising, outlier elimination, and missing value imputation, and construct a processed real-time dataset after dimensionless processing.

The startup priority analysis module is configured to analyze and determine a current startup sequence of each unit based on relevant unit operation data in the processed real-time dataset and a load demand Dfyq of a power grid, so as to acquire a unit startup priority Qyxj; determine, based on a value of the unit startup priority Qyxj, a startup sequence and whether there is a fault risk for each unit; and trigger a trend analysis instruction if there is a fault risk.

The fault identification module is configured to receive the trend analysis instruction, analyze current fault evaluation index Ggzs_{c} of each unit during operation based on relevant equipment status data in the processed real-time dataset, and determine, based on the historical dataset, whether the corresponding unit needs to be maintained.

The effect feedback and optimization module is configured to perform feedback based on an actual effect formed by the startup sequence of each unit, acquire relevant feedback data, evaluate a balance effect between a response capability of a power grid load and unit operation efficiency based on the relevant feedback data to construct performance feedback index Xfzs, and adjust and optimize a load capacity of the corresponding unit based on the performance feedback index Xfzs.

During operation of the system, through the real-time monitoring performed by the data acquisition module on the unit operation data and the equipment status data, combined with mining and analysis of the historical dataset, dynamic changes in the load demand Dfyq of the power grid and a unit status can be grasped. Based on the startup priority analysis module, the system can dynamically calculate the unit startup priority Qyxj, and perform relatively optimal startup-shutdown scheduling of the unit based on the value of the unit startup priority Qyxj. This improves a response capability of the unit to a fluctuation in the load demand of the power grid, avoids a delay problem in traditional startup-shutdown scheduling, and thereby effectively ensures operational stability of the power grid. The preprocessing performed by the data processing module on the real-time dataset (including the denoising, the outlier elimination, the missing value imputation, and the dimensionless processing) guarantees data quality, providing an accurate input for subsequent optimization analysis. Based on the processed real-time dataset and the load demand of the power grid, the startup priority analysis module can preferentially schedule a unit with high operation efficiency and good economic performance. A load distribution quantity of the unit is accurately calculated, which avoids a waste of energy and unnecessary fuel consumption, thereby reducing an overall operation cost of the unit and improving power generation efficiency. By means of the trend analysis instruction, the fault identification module can calculate the fault evaluation index during unit operation based on the equipment status data in the real-time dataset and the historical dataset, and predict a potential risk based on a historical operation trend. The fault identification module can not only accurately determine whether the unit needs to be maintained, but also help operation and maintenance personnel formulate a maintenance plan in advance, thereby avoiding an unplanned shutdown of the unit due to a sudden fault. Through intelligent fault identification and prediction, availability of the unit is significantly improved, and downtime and maintenance costs are reduced. Based on an actual operation effect of the startup sequence of each unit, the effect feedback and optimization module dynamically evaluates a balance status between the response capability of the power grid load and the unit operation efficiency by constructing the performance feedback index Xfzs. The system can adjust and optimize the load distribution quantity of the corresponding unit based on the feedback data, forming a closed-loop control process to continuously improve startup-shutdown scheduling and load distribution. In summary, through in-depth application of an industrial big data technology combined with intelligent startup-shutdown priority analysis and fault prediction mechanisms, this method significantly improves operating efficiency and economic performance of the coal-fired power generating unit, enhances the response capability of the power grid load, and reduces an economic loss caused by a fault-incurred shutdown. This optimization system injects concepts of intelligence and greenization into the traditional coal-fired power generation industry, providing powerful technical support for energy management and sustainable development.

### Embodiment 2

Referring to FIG. 1, specifically, the data acquisition module includes a real-time monitoring unit and a historical extraction unit.

The real-time monitoring unit is configured to monitor, by using the plurality of monitoring instruments, the relevant unit operation data and the relevant equipment status data of each coal-fired power generating unit in real time, where the relevant unit operation data includes fuel consumption Rxz per unit time, load output value Fsz, availability coefficient Kyz at each time point, unit load fluctuation factor Fbyz, and maximum target power generation load value Fbzₘₐₓ of each unit; the relevant equipment status data includes boiler pressure fluctuation factor Ybyz₁ and steam pipeline pressure fluctuation factor Ybyz₂; the plurality of monitoring instruments include a laser-type coal flow meter, a power monitoring instrument, and a unit performance testing instrument; and the real-time dataset includes the relevant unit operation data and the relevant equipment status data.

The historical extraction unit is configured to acquire, by using the big data technology, relevant unit operation data and relevant equipment status data of each coal-fired power generating unit in an industrial park in the historical time period, and the historical dataset includes the relevant unit operation data and the relevant equipment status data in the historical time period.

The data processing module includes a preprocessing unit and a normalization unit.

The preprocessing unit is configured to perform preprocessing on the relevant data in the real-time dataset, where the preprocessing includes the denoising, the missing value imputation, the outlier elimination, and data smoothing, and methods for the missing value imputation include mean imputation, median imputation, interpolation imputation, and regression imputation.

The normalization unit is configured to eliminate, by using a dimensionless processing technology, a unit difference of relevant data in the preprocessed real-time dataset, such that a range of the relevant data in the preprocessed real-time dataset falls within [0, 1].

In this embodiment, the real-time monitoring unit in the data acquisition module monitors, by using the plurality of monitoring instruments (including a boiler, a steam pipeline, and the like), the unit operation data and the equipment status data in real time, and generates the real-time dataset. The real-time data can fully reflect an immediate operation status and equipment health status of the unit. In addition, the historical extraction unit extracts historical operation data and equipment status data of each unit in the industrial park through the big data technology to form the historical dataset. Such a combination of the real-time and historical data provides a multi-dimensional reference basis for analyzing a unit operation law, predicting a trend, and optimizing an operation strategy, thereby enhancing a depth and comprehensiveness of data analysis. The preprocessing unit in the data processing module significantly improves quality and integrity of the real-time data through the denoising, the outlier elimination, the data smoothing, and the missing value imputation. Specifically, the denoising effectively eliminates random noise interference during monitoring, thereby ensuring data accuracy. The outlier elimination avoids an impact of an extreme value on data analysis and optimization results. The missing value imputation offers a plurality of imputation methods (the mean imputation, the median imputation, the interpolation imputation, and the regression imputation), thereby flexibly adapting to processing needs of different data types and further ensuring data integrity. The data smoothing eliminates a sharp data fluctuation, improves data continuity and trendiness, and provides stable basic data for subsequent optimization analysis. The normalization unit in the data processing module uses the dimensionless processing technology to eliminate the unit difference in the preprocessed real-time dataset, enabling data with different dimensions to be unified within a same range. For example, the fuel consumption per unit time and the load output value can be compared and optimized under a same standard after the dimensionless processing. This processing eliminates a limitation of a physical unit on the data analysis, significantly improving data comparability and accuracy of model analysis. Through combination of the real-time monitoring unit and the historical extraction unit, the system can comprehensively monitor an operation status and an equipment status of the coal-fired power generating unit in real time, and conduct in-depth analysis based on the historical data, thereby providing data support for optimizing the unit operation.

### Embodiment 3

Referring to FIG. 1, specifically, the startup priority analysis module includes an operation status analysis unit, a priority unit, and a preliminary determination unit.

The operation status analysis unit is configured to extract the fuel consumption Rxz per unit time and the load output value Fsz of each unit from the relevant unit operation data in the processed real-time dataset, and calculate economic index Jzb of each unit based on the fuel consumption Rxz per unit time and the load output value Fsz of each unit, where the economic index Jzb of each unit is specifically acquired according to a following formula:

$$Jzb = \frac{Rxz}{Fsz}$$

where the economic index Jzb of each unit is a power generation cost per unit time of the unit (usually in units of yuan per kilowatt-hour). It reflects economic performance of the unit operation, specifically a fuel consumption and an operation cost that are required for the unit to generate 1 kilowatt-hour of electrical energy; a low value of the economic index Jzb indicates that the unit has a low operation cost and better economic performance; conversely, it indicates that the unit has a high operation cost and poorer economic performance;
the fuel consumption Rxz per unit time of each unit can be monitored and obtained through the laser-type coal flow meter; and
the load output value Fsz is a power output of the unit, which can be monitored and obtained through the power monitoring instrument; and
calculate target power generation load value Fbz of each unit in different monitoring time periods based on the economic index Jzb of each unit and the load demand Dfyq of the power grid, where the target power generation load value Fbz of each unit in the different monitoring time periods is specifically acquired according to a following formula:

$$Fbz ( t ) = \frac{Dfyq ( t ) * {Jzb}^{- 1}}{{\sum }_{i = 1}^{n} {Jzb}^{- 1}}$$

where in the above formula, Fbz(t) represents a target power generation load value of the corresponding unit at a time point t, Dfyq(t) represents a load demand of the power grid at the time point t, Jzb⁻¹ represents an economic weight of the corresponding unit, namely a reciprocal of the economic index Jzb of the corresponding unit, n represents a quantity of units, and i=1, 2, 3, . . . , n.

The load demand Dfyq of the power grid at each time point is obtained by monitoring a real-time load demand of the power grid through a power grid monitoring system, including a variation trend of the load demand, peak and valley loads, and the like.

In this embodiment, the operation status analysis unit in the startup priority analysis module can extract the fuel consumption per unit time and the load output value of each unit from the real-time dataset, and calculate the economic index, namely the power generation cost per unit time, based on the fuel consumption per unit time and the load output value. The economic index accurately quantifies an operation cost of each unit and reflects economic differences among different units. By giving priority to a unit with a low operation cost and good economic performance, the system scientifically sorts unit startup-shutdown priorities, reducing an adverse impact of blind startup-shutdown on the fuel consumption and the operation efficiency. By analyzing the economic index and the real-time load demand of the power grid, the system calculates a target power generation load value of each unit according to the formula to ensure accurate distribution of the load demand of the power grid. Specifically, the system distributes a load based on an economic weight of each unit. A unit with a low value of the economic index (a low operation cost) will be preferentially allocated a high target power generation load value. This load distribution mechanism significantly improves overall economic performance of a power generation system, reduces the fuel consumption and the power generation cost, and optimizes a dynamic response capability of the power grid load. Distribution optimization of load targets among a plurality of units not only meets a power grid demand but also avoids a problem of overloading or idleness of an individual unit, thereby improving utilization efficiency of unit resources.

### Embodiment 4

Referring to FIG. 1, specifically, the priority unit is configured to analyze and determine the current startup sequence of each unit based on the relevant unit operation data in the processed real-time dataset and a current load demand of the power grid, so as to acquire the unit startup priority Qyxj, where the unit startup priority Qyxj is specifically acquired according to a following formula:

$$Qyxj ( t ) = \frac{{Jzb}^{- 1} * Kyz ( t ) * {Fbz}_{max}}{Fbz ( t ) + ∈}$$

where in the above formula, Qyxj(t) represents a unit startup priority of the corresponding unit at the time point t, Kyz(t) represents an availability coefficient of the corresponding unit at the time point t, Fbzₘₐₓ represents the maximum target power generation load value of the corresponding unit, and ∈ represents a correction constant, which is a constant used to avoid a divide-by-zero error.

The maximum target power generation load value Fbzₘₐₓ of the corresponding unit can be obtained by testing an output of the unit under a rated condition by using the unit performance testing instrument.

The availability coefficient Kyz(t) of the corresponding unit at the time point t is determined based on an operation status of the unit. The operation status of the unit includes whether the unit is under maintenance, whether a fault occurs, and whether the unit is in a standby state. When the unit is in the standby state, a corresponding value of the availability coefficient is 1. If the unit is not in the standby state, the corresponding value of the availability coefficient is 0.

The preliminary determination unit is configured to separately acquire the unit startup priority Qyxj for each unit according to a method of acquiring the unit startup priority Qyxj in the priority unit, and perform sorting to generate a sequence group; determine the unit startup priority Qyxj for the corresponding unit in the historical time period based on the historical dataset, and acquire average unit startup priority Qyxj_{avg} of the corresponding unit by combining a statistical mean algorithm; and compare the unit startup priority Qyxj of a current unit with the average unit startup priority Qyxj_{avg} of the corresponding unit to determine a startup sequence and whether there is a fault risk for the corresponding unit, where preliminary determination content is specifically as follows:
if the unit startup priority Qyxj for the current unit is greater than or equal to the average unit startup priority Qyxj_{avg} of the corresponding unit, preliminarily determining that there is no fault risk in the corresponding unit currently, such that the trend analysis instruction is not triggered temporarily, the corresponding unit is retained in the sequence group, and the corresponding unit is marked as a normal unit; or
if the unit startup priority Qyxj for the current unit is less than the average unit startup priority Qyxj_{avg} of the corresponding unit, preliminarily determining that there is a fault risk in the corresponding unit, such that the trend analysis instruction is triggered, the corresponding unit is removed from the sequence group, and the corresponding unit is marked as an abnormal unit; and
count the normal unit based on the preliminary determination content, perform re-sorting to generate an optimized sequence group, and determine a startup sequence of each normal unit based on the optimized sequence group.

In this embodiment, the priority unit dynamically calculates the unit startup priority Qyxj for each unit based on key parameters such as the availability coefficient and the maximum load output value of the unit in the real-time dataset and the load demand of the power grid. This calculation method ensures that while meeting the load demand of the power grid, the system preferentially starts a unit with a good status and high operational economic performance. Through statistical analysis of the historical dataset, the system acquires the average startup priority of each unit, and accurately identifies, by comparing a current priority with a historical average priority, whether a current startup status of the unit meets an expectation, thereby further optimizing the unit startup sequence. The preliminary determination unit quickly identifies an abnormal status of the unit by calculating the startup priority Qyxj of the unit in real time and comparing the calculated startup priority Qyxj with the historical average priority. When the startup priority Qyxj is less than the average startup priority, the unit is preliminarily determined to have a fault risk, and the trend analysis instruction is promptly triggered to further confirm a source of a problem. When the startup priority Qyxj is greater than or equal to the average startup priority, the unit is determined to be in a normal status, avoiding unnecessary maintenance or interruption. This mechanism achieves early warning of a potential fault, effectively reduces a risk of an unplanned equipment shutdown, and extends an equipment operation life. Based on a preliminary determination result, the system automatically eliminates the abnormal unit, re-sorts the normal unit, and generates an optimized unit startup sequence. The optimized sequence group further improves the response capability of the power grid load, ensures that a unit with good economic performance and a stable status is preferentially started, prevents an inefficient unit or a unit with a potential risk from being put into operation, and reduces the fuel consumption and the operation cost.

### Embodiment 5

Referring to FIG. 1, specifically, the fault identification module includes a fault analysis unit and an identification unit.

The fault analysis unit is configured to, after receiving the trend analysis instruction, analyze the current fault evaluation index Ggzs_{c} of each current abnormal unit during the operation based on the relevant equipment status data in the processed real-time dataset after the dimensionless processing, where the current fault evaluation index Ggzs_{c} is acquired according to a following formula:

$${Ggzs}_{c} = \frac{Δ Qyxj * α + {Ybyz}_{1} * β + {Ybyz}_{2} * γ + Fbyz * φ}{α + β + γ + φ}$$

where in the above formula, ΔQyxj represents a unit startup priority difference, Ybyz₁ represents the boiler pressure fluctuation factor, Ybyz₂ represents the steam pipeline pressure fluctuation factor, Fbyz represents the unit load fluctuation factor, and α, β, γ, and φ all represent weight values, where 0<α<1, 0<β<1, 0<γ<1, 0<φ<1, and specific values of the α, the β, the γ, and the φ are set by a user based on a situation.

The unit startup priority difference ΔQyxj is a difference between a current startup priority of the corresponding unit and a startup priority obtained in previous monitoring.

The boiler pressure fluctuation factor Ybyz₁ and the steam pipeline pressure fluctuation factor Ybyz₂ will be calculated based on a standard deviation. The standard deviation reflects a dispersion degree of a pressure signal, that is, a deviation of a pressure value from its average value.

The identification unit is configured to determine a time point when a current corresponding abnormal unit is last marked as an abnormal unit to mark the time point as a start timestamp, and mark a current time point as an end timestamp; acquire a time interval based on the start timestamp and the end timestamp, and use the time interval as a comparison time period; extract fault evaluation index Ggzsₕ at the start timestamp from the historical dataset based on the start timestamp; and compare the current fault evaluation index Ggzs_{c} of each unit during the operation with the fault evaluation index Ggzsₕ at the start timestamp to determine whether the corresponding abnormal unit needs to be maintained, where specific content is as follows:
If the current fault evaluation index Ggzs_{c} of each unit during the operation exceeds the fault evaluation index Ggzsₕ at the start timestamp, a maintenance instruction is issued, and maintenance personnel is arranged to perform on-site maintenance; or
if the current fault evaluation index Ggzs_{c} of each unit during the operation does not exceed the fault evaluation index Ggzsₕ at the start timestamp, no maintenance instruction is issued temporarily.

In this embodiment, after receiving the trend analysis instruction, the fault analysis unit uses the equipment status data in the real-time dataset to eliminate a data dimension difference through the dimensionless processing, ensuring that fault characteristic parameters of different natures can be analyzed under a unified standard. The current fault evaluation index is calculated by using the formula, and multi-dimensional data such as the unit startup priority difference, the boiler pressure fluctuation factor, the steam pipeline pressure fluctuation factor, and the unit load fluctuation factor is combined and assigned different weights to comprehensively evaluate a current fault risk of the unit. This fault evaluation method fully considers a plurality of core parameters affecting stability of the unit operation, avoids misjudgment or omission that may be caused by determination based on a single parameter, realizes quantitative analysis of a fault risk of the abnormal unit, and significantly improves scientificity and accuracy of fault evaluation. The identification unit dynamically tracks a fault change trend of the abnormal unit based on the current time point and the historical data. Specifically, the time point when the abnormal unit is last marked as abnormal is taken as the start timestamp, and the current time point is marked as the end timestamp. The time interval is calculated, and historical data within the time period is extracted. By comparing the current fault evaluation index with the fault evaluation index at the start timestamp, a fault risk development trend of the unit is accurately determined. If the fault evaluation index continues to increase and exceeds a historical value, the system immediately issues the maintenance instruction to ensure that the fault can be handled in a timely manner. If the fault evaluation index does not exceed the historical value, the system suspends the maintenance instruction to avoid unnecessary maintenance operations. This dynamic fault analysis method based on the time interval can significantly reduce a waste of resources due to over-maintenance, while ensuring that the potential fault is removed promptly before it deteriorates.

### Embodiment 6

Referring to FIG. 1, specifically, the effect feedback and optimization module includes an effect feedback unit and an optimization unit.

The effect feedback unit is configured to: perform the feedback based on the actual effect formed by the startup sequence of each unit, and acquire the relevant feedback data, where the relevant feedback data includes a quantity m of normal units, a load output value of a corresponding normal unit at each time point, a target power generation load value of the corresponding normal unit at each time point, and a fuel consumption of the corresponding normal unit at each time point; and evaluate the balance effect between the response capability of the power grid load and the unit operation efficiency based on the relevant feedback data, and perform the dimensionless processing to construct the performance feedback index Xfzs, where the performance feedback index Xfzs is acquired according to a following formula:

$$Xfzs ( t ) = {\sum }_{k = 1}^{m} \vert {Fsz}_{k} ( t ) - {Fbz}_{k} ( t ) \vert + ω * {\sum }_{k = 1}^{m} ( \frac{{Rxz}_{k} ( t )}{{Fsz}_{k} ( t )} )$$

where in the above formula, k=1, 2, . . . , m, m represents the quantity of normal units, Xfzs(t) represents a performance feedback index at the time point t, Fszₖ(t) represents a load output value of a k^{th} normal unit at the time point t, Fbzₖ(t) represents a target power generation load value of the k^{th} normal unit at the time point t, Rxzₖ(t) represents a fuel consumption of the k^{th} normal unit at the time point t, ω represents a weight coefficient, which is used to balance a relationship between a load error and a fuel consumption, |FSZₖ(t)−Fbzₖ(t)| represents a deviation between an actual load output and a target load; and

$$\frac{{Rxz}_{k} ( t )}{{Fsz}_{k} ( t )}$$

reflects economic performance of fuel, where a smaller value indicates less fuel consumed for electricity generation per unit and better economic performance.

The optimization unit is configured to adjust and optimize the load capacity of the corresponding unit based on the performance feedback index Xfzs by using a gradient descent method, so as to acquire load adjustment amount Ft of the corresponding unit at each subsequent time point:

$$Ft ( t ) = - η * \frac{ϑ Xfzs ( t )}{ϑ {Fsz}_{k} ( t )}$$

where in the above formula, Xfzs(t) represents the performance feedback index at the time point t, η represents a learning rate, which is used to control an adjustment amplitude, and

$$\frac{ϑ Xfzs ( t )}{ϑ {Fsz}_{k} ( t )}$$

represents a partial derivative of the performance feedback index at the time point t with respect to the load output value of the unit at the time point t.

In this embodiment, the effect feedback unit comprehensively evaluates the balance effect between the response capability of the power grid load and the unit operation efficiency through real-time acquisition and dimensionless processing of operation data (including a load output value, a target power generation load value, and a fuel consumption) of each normal unit. The performance feedback index Xfzs constructed according to the formula comprehensively considers the deviation between the load output and the target load of the unit, as well as the economic performance of the fuel (a fuel consumption for the electricity generation per unit), providing a scientific quantitative criterion for optimizing the unit operation. This index can not only reflect a current operation status of the unit, but also help analyze whether a load distribution strategy is efficient, serving as an important input basis for gradient adjustment of the optimization unit. The partial derivative of the performance feedback index with respect to the load output value of unit is calculated, so as to accurately identify a key variable affecting the operation efficiency. The adjustment amplitude is controlled through the learning rate to avoid instability caused by over-adjustment. The load distribution is gradually optimized by using a gradient descent algorithm, such that the system can dynamically adjust the load adjustment amount Ft of the unit at each subsequent time point, ensuring that the load distribution achieves optimal economic performance while meeting the power grid demand, and significantly improving adjustment efficiency and accuracy of the load distribution. The effect feedback unit and the optimization unit form a closed-loop feedback mechanism. Through real-time calculation of the performance feedback index Xfzs and dynamic adjustment by the gradient descent method, the system can continuously optimize the load distribution strategy based on an operation effect. This closed-loop mechanism effectively avoids a limitation caused by a static parameter in a traditional load distribution strategy, enabling the system to flexibly respond to a load fluctuation of the power grid and a dynamic change in a unit operation status, and improving stability and economic performance of overall operation. By constructing the performance feedback index Xfzs, the present disclosure realizes scientific quantification of the unit operation efficiency and the response capability of the power grid load, and dynamically optimizes unit load distribution based on the scientific quantification, thereby significantly enhancing economic performance and flexibility of the coal-fired power generating unit. An optimization strategy of the gradient descent method can quickly respond to a change in the operation status and dynamically adjust the unit load distribution, thereby avoiding problems of over-adjustment or lagged adjustment in the traditional strategy, and enhancing accuracy and flexibility of the load distribution.

### Embodiment 7

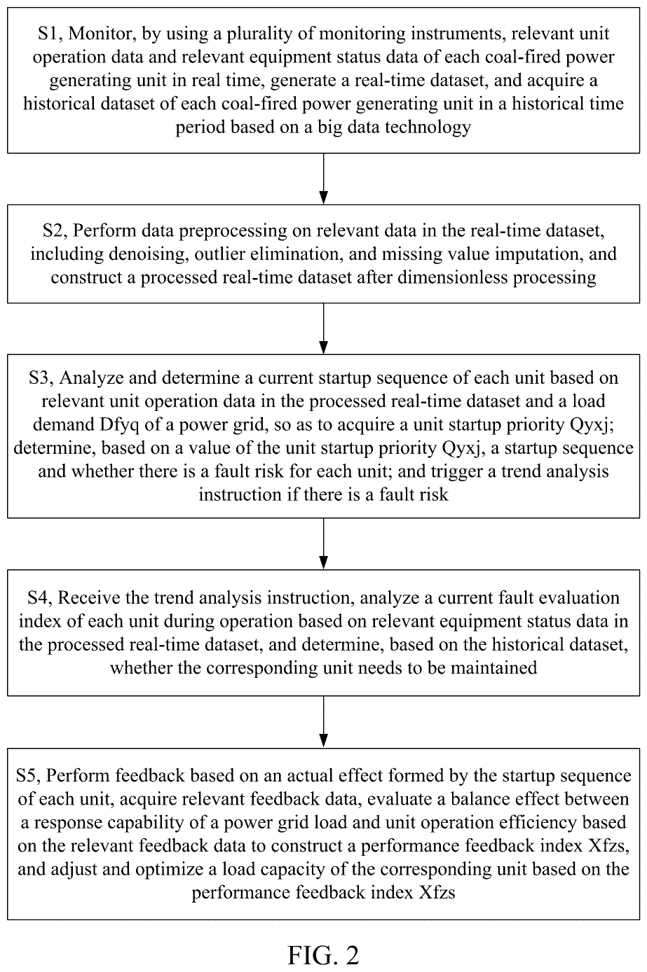

Referring to FIG. 2, specifically, an industrial big data-based method for operational optimization of a coal-fired power generating unit includes the following steps:
S1: Relevant unit operation data and relevant equipment status data of each coal-fired power generating unit are monitored in real time by using a plurality of monitoring instruments, a real-time dataset is generated, and a historical dataset of each coal-fired power generating unit in a historical time period is acquired based on a big data technology.
S2: Data preprocessing is performed on relevant data in the real-time dataset, including denoising, outlier elimination, and missing value imputation, and a processed real-time dataset is constructed after dimensionless processing.
S3: A current startup sequence of each unit is analyzed and determined based on relevant unit operation data in the processed real-time dataset and load demand Dfyq of a power grid, so as to acquire unit startup priority Qyxj; a startup sequence and whether there is a fault risk are determined for each unit based on a value of the unit startup priority Qyxj; and a trend analysis instruction is triggered if there is a fault risk.
S4: The trend analysis instruction is received, current fault evaluation index Ggzs_{c} of each unit during operation is analyzed based on relevant equipment status data in the processed real-time dataset, and whether the corresponding unit needs to be maintained is determined based on the historical dataset.
S5: Feedback is performed based on an actual effect formed by the startup sequence of each unit, relevant feedback data is acquired, a balance effect between a response capability of a power grid load and unit operation efficiency is evaluated based on the relevant feedback data to construct performance feedback index Xfzs, and a load capacity of the corresponding unit is adjusted and optimized based on the performance feedback index Xfzs.

Although the embodiments of the present disclosure have been illustrated and described, it should be understood that those of ordinary skill in the art may make various changes, modifications, replacements, and variations to the above embodiments without departing from the principle and spirit of the present disclosure, and the scope of the present disclosure is limited by the appended claims and their legal equivalents.

What is claimed is:

1. An industrial big data-based system for operational optimization of a coal-fired power generating unit, comprising a data acquisition module, a data processing module, a startup priority analysis module, a fault identification module, and an effect feedback and optimization module, wherein
the data acquisition module is configured to monitor, by using a plurality of monitoring instruments, relevant unit operation data and relevant equipment status data of each coal-fired power generating unit in real time, generate a real-time dataset, and acquire a historical dataset of each coal-fired power generating unit in a historical time period based on a big data technology;
the data processing module is configured to perform data preprocessing on relevant data in the real-time dataset, comprising denoising, outlier elimination, and missing value imputation, and construct a processed real-time dataset after dimensionless processing;
the startup priority analysis module is configured to analyze and determine a current startup sequence of each unit based on relevant unit operation data in the processed real-time dataset and a load demand Dfyq of a power grid, so as to acquire a unit startup priority Qyxj;
determine, based on a value of the unit startup priority Qyxj, a startup sequence and whether there is a fault risk for each unit; and trigger a trend analysis instruction if there is a fault risk;
the fault identification module is configured to receive the trend analysis instruction, analyze a current fault evaluation index Ggzs_{c} of each unit during operation based on relevant equipment status data in the processed real-time dataset, and determine, based on the historical dataset, whether the corresponding unit needs to be maintained; and
the effect feedback and optimization module is configured to perform feedback based on an actual effect formed by the startup sequence of each unit, acquire relevant feedback data, evaluate a balance effect between a response capability of a power grid load and unit operation efficiency based on the relevant feedback data to construct a performance feedback index Xfzs, and adjust and optimize a load capacity of the corresponding unit based on the performance feedback index Xfzs.

2. The industrial big data-based system for the operational optimization of the coal-fired power generating unit according to claim 1, wherein the data acquisition module comprises a real-time monitoring unit and a historical extraction unit;
the real-time monitoring unit is configured to monitor, by using the plurality of monitoring instruments, the relevant unit operation data and the relevant equipment status data of each coal-fired power generating unit in real time, wherein the relevant unit operation data comprises a fuel consumption Rxz per unit time, a load output value Fsz, an availability coefficient Kyz at each time point, a unit load fluctuation factor Fbyz, and a maximum target power generation load value Fbzₘₐₓ of each unit; the relevant equipment status data comprises a boiler pressure fluctuation factor Ybyz₁ and a steam pipeline pressure fluctuation factor Ybyz₂; the plurality of monitoring instruments comprise a laser-type coal flow meter, a power monitoring instrument, and a unit performance testing instrument; and the real-time dataset comprises the relevant unit operation data and the relevant equipment status data; and
the historical extraction unit is configured to acquire, by using the big data technology, relevant unit operation data and relevant equipment status data of each coal-fired power generating unit in an industrial park in the historical time period, and the historical dataset comprises the relevant unit operation data and the relevant equipment status data in the historical time period.

3. The industrial big data-based system for the operational optimization of the coal-fired power generating unit according to claim 2, wherein the data processing module comprises a preprocessing unit and a normalization unit;
the preprocessing unit is configured to perform preprocessing on the relevant data in the real-time dataset, wherein the preprocessing comprises the denoising, the missing value imputation, the outlier elimination, and data smoothing, and methods for the missing value imputation comprise mean imputation, median imputation, interpolation imputation, and regression imputation; and
the normalization unit is configured to eliminate, by using a dimensionless processing technology, a unit difference of relevant data in the preprocessed real-time dataset, such that a range of the relevant data in the preprocessed real-time dataset falls within [0, 1].

4. The industrial big data-based system for the operational optimization of the coal-fired power generating unit according to claim 3, wherein the startup priority analysis module comprises an operation status analysis unit, a priority unit, and a preliminary determination unit;
the operation status analysis unit is configured to extract the fuel consumption Rxz per unit time and the load output value Fsz of each unit from the relevant unit operation data in the processed real-time dataset, and calculate an economic index Jzb of each unit based on the fuel consumption Rxz per unit time and the load output value Fsz of each unit, wherein the economic index Jzb of each unit is specifically acquired according to a following formula:
$$Jzb = \frac{Rxz}{Fsz} ;$$
and
calculate a target power generation load value Fbz of each unit in different monitoring time periods based on the economic index Jzb of each unit and the load demand Dfyq of the power grid, wherein the target power generation load value Fbz of each unit in the different monitoring time periods is specifically acquired according to a following formula:
$$Fbz ( t ) = \frac{Dfyq ( t ) * {Jzb}^{- 1}}{{\sum }_{i = 1}^{n} {Jzb}^{- 1}}$$
wherein in the above formula, Fbz(t) represents a target power generation load value of the corresponding unit at a time point t, Dfyq(t) represents a load demand of the power grid at the time point t, Jzb⁻¹ represents an economic weight of the corresponding unit, n represents a quantity of units, and i=1, 2, 3, . . . , n.

5. The industrial big data-based system for the operational optimization of the coal-fired power generating unit according to claim 4, wherein the priority unit is configured to analyze and determine the current startup sequence of each unit based on the relevant unit operation data in the processed real-time dataset and a current load demand of the power grid, so as to acquire the unit startup priority Qyxj, wherein the unit startup priority Qyxj is specifically acquired according to a following formula:
$$Qyxj ( t ) = \frac{{Jzb}^{- 1} * Kyz ( t ) * {Fbz}_{max}}{Fbz ( t ) + ∈}$$
wherein in the above formula, Qyxj(t) represents a unit startup priority of the corresponding unit at the time point t, Kyz(t) represents an availability coefficient of the corresponding unit at the time point t, Fbzₘₐₓ represents the maximum target power generation load value of the corresponding unit, and E represents a correction constant.

6. The industrial big data-based system for the operational optimization of the coal-fired power generating unit according to claim 5, wherein the preliminary determination unit is configured to separately acquire the unit startup priority Qyxj for each unit according to a method of acquiring the unit startup priority Qyxj in the priority unit, and perform sorting to generate a sequence group; determine the unit startup priority Qyxj for the corresponding unit in the historical time period based on the historical dataset, and acquire an average unit startup priority Qyxj_{avg} of the corresponding unit by combining a statistical mean algorithm; and compare the unit startup priority Qyxj for a current unit with the average unit startup priority Qyxj_{avg} of the corresponding unit to determine a startup sequence and whether there is a fault risk for the corresponding unit, wherein preliminary determination content is specifically as follows:
in response to that the unit startup priority Qyxj for the current unit is greater than or equal to the average unit startup priority Qyxj_{avg} of the corresponding unit, preliminarily determining that there is no fault risk in the corresponding unit currently, such that the trend analysis instruction is not triggered temporarily, the corresponding unit is retained in the sequence group, and the corresponding unit is marked as a normal unit; or
in response to that the unit startup priority Qyxj for the current unit is less than the average unit startup priority Qyxj_{avg} of the corresponding unit, preliminarily determining that there is a fault risk in the corresponding unit, such that the trend analysis instruction is triggered, the corresponding unit is removed from the sequence group, and the corresponding unit is marked as an abnormal unit; and
count the normal unit based on the preliminary determination content, perform re-sorting to generate an optimized sequence group, and determine a startup sequence of each normal unit based on the optimized sequence group.

7. The industrial big data-based system for the operational optimization of the coal-fired power generating unit according to claim 3, wherein the fault identification module comprises a fault analysis unit and an identification unit;
the fault analysis unit is configured to, after receiving the trend analysis instruction, analyze the current fault evaluation index Ggzs_{c} of each current abnormal unit during the operation based on the relevant equipment status data in the processed real-time dataset after the dimensionless processing, wherein the current fault evaluation index Ggzs_{c} is acquired according to a following formula:
$${Ggzs}_{c} = \frac{Δ Qyxj * α + {Ybyz}_{1} * β + {Ybyz}_{2} * γ + Fbyz * φ}{α + β + γ + φ}$$
wherein in the above formula, ΔQyxj represents a unit startup priority difference, Ybyz₁ represents the boiler pressure fluctuation factor, Ybyz₂ represents the steam pipeline pressure fluctuation factor, Fbyz represents the unit load fluctuation factor, and α, β, γ, and φ all represent weight values, wherein 0<α<1, 0<β<1, 0<γ<1, 0<φ<1, and specific values of the α, the β, the γ, and the φ are set by a user based on a situation; and
the identification unit is configured to determine a time point in response to that a current corresponding abnormal unit is last marked as an abnormal unit to mark the time point as a start timestamp, and mark a current time point as an end timestamp; acquire a time interval based on the start timestamp and the end timestamp, and use the time interval as a comparison time period; extract a fault evaluation index Ggzsₕ at the start timestamp from the historical dataset based on the start timestamp; and compare the current fault evaluation index Ggzs_{c} of each unit during the operation with the fault evaluation index Ggzsₕ at the start timestamp to determine whether the corresponding abnormal unit needs to be maintained, wherein specific content is as follows:
in response to that the current fault evaluation index Ggzs_{c} of each unit during the operation exceeds the fault evaluation index Ggzsₕ at the start timestamp, a maintenance instruction is issued, and maintenance personnel is arranged to perform on-site maintenance; or
in response to that the current fault evaluation index Ggzs_{c} of each unit during the operation does not exceed the fault evaluation index Ggzsₕ at the start timestamp, no maintenance instruction is issued temporarily.

8. The industrial big data-based system for the operational optimization of the coal-fired power generating unit according to claim 1, wherein the effect feedback and optimization module comprises an effect feedback unit and an optimization unit;
the effect feedback unit is configured to: perform the feedback based on the actual effect formed by the startup sequence of each unit, and acquire the relevant feedback data, wherein the relevant feedback data comprises a quantity m of normal units, a load output value of a corresponding normal unit at each time point, a target power generation load value of the corresponding normal unit at each time point, and a fuel consumption of the corresponding normal unit at each time point; and evaluate the balance effect between the response capability of the power grid load and the unit operation efficiency based on the relevant feedback data, and perform the dimensionless processing to construct the performance feedback index Xfzs, wherein the performance feedback index Xfzs is acquired according to a following formula:
$$Xfzs ( t ) = {\sum }_{k = 1}^{m} \vert {Fsz}_{k} ( t ) - {Fbz}_{k} ( t ) \vert + ω * {\sum }_{k = 1}^{m} ( \frac{{Rxz}_{k} ( t )}{{Fsz}_{k} ( t )} )$$
wherein in the above formula, k=1, 2, . . . , m, m represents the quantity of normal units, Xfzs(t) represents a performance feedback index at a time point t, Fszₖ(t) represents a load output value of a k^{th} normal unit at the time point t, Fbzₖ(t) represents a target power generation load value of the k^{th} normal unit at the time point t, Rxzₖ(t) represents a fuel consumption of the k^{th} normal unit at the time point t, and w represents a weight coefficient.

9. The industrial big data-based system for the operational optimization of the coal-fired power generating unit according to claim 8, wherein the optimization unit is configured to adjust and optimize the load capacity of the corresponding unit based on the performance feedback index Xfzs by using a gradient descent method, so as to acquire a load adjustment amount Ft of the corresponding unit at each subsequent time point:
$$Ft ( t ) = - η * \frac{ϑ Xfzs ( t )}{ϑ {Fsz}_{k} ( t )}$$
wherein in the above formula, Xfzs(t) represents the performance feedback index at the time point t, η represents a learning rate, and
$$\frac{ϑ Xfzs ( t )}{ϑ {Fsz}_{k} ( t )}$$
represents a partial derivative of the performance feedback index at the time point t with respect to the load output value of the unit at the time point t.

10. An industrial big data-based method for operational optimization of a coal-fired power generating unit, used to implement the industrial big data-based system for the operational optimization of the coal-fired power generating unit according to claim 1, and comprising:
S1, monitoring, by using the plurality of monitoring instruments, the relevant unit operation data and the relevant equipment status data of each coal-fired power generating unit in real time, generating the real-time dataset, and acquiring the historical dataset of each coal-fired power generating unit in the historical time period based on the big data technology;
S2, performing the data preprocessing on the relevant data in the real-time dataset, comprising the denoising, the outlier elimination, and the missing value imputation, and constructing the processed real-time dataset after the dimensionless processing;
S3, analyzing and determining the current startup sequence of each unit based on the relevant unit operation data in the processed real-time dataset and the load demand Dfyq of the power grid, so as to acquire the unit startup priority Qyxj; determining, based on the value of the unit startup priority Qyxj, the startup sequence and whether there is the fault risk for each unit; and triggering the trend analysis instruction if there is the fault risk;
S4, receiving the trend analysis instruction, analyzing the current fault evaluation index Ggzs_{c} of each unit during the operation based on the relevant equipment status data in the processed real-time dataset, and determining, based on the historical dataset, whether the corresponding unit needs to be maintained; and
S5, performing the feedback based on the actual effect formed by the startup sequence of each unit, acquiring the relevant feedback data, evaluating the balance effect between the response capability of the power grid load and the unit operation efficiency based on the relevant feedback data to construct the performance feedback index Xfzs, and adjusting and optimizing the load capacity of the corresponding unit based on the performance feedback index Xfzs.

11. The industrial big data-based method according to claim 10, wherein in the industrial big data-based system, the data acquisition module comprises a real-time monitoring unit and a historical extraction unit;
the real-time monitoring unit is configured to monitor, by using the plurality of monitoring instruments, the relevant unit operation data and the relevant equipment status data of each coal-fired power generating unit in real time, wherein the relevant unit operation data comprises a fuel consumption Rxz per unit time, a load output value Fsz, an availability coefficient Kyz at each time point, a unit load fluctuation factor Fbyz, and a maximum target power generation load value Fbzₘₐₓ of each unit; the relevant equipment status data comprises a boiler pressure fluctuation factor Ybyz₁ and a steam pipeline pressure fluctuation factor Ybyz₂; the plurality of monitoring instruments comprise a laser-type coal flow meter, a power monitoring instrument, and a unit performance testing instrument; and the real-time dataset comprises the relevant unit operation data and the relevant equipment status data; and
the historical extraction unit is configured to acquire, by using the big data technology, relevant unit operation data and relevant equipment status data of each coal-fired power generating unit in an industrial park in the historical time period, and the historical dataset comprises the relevant unit operation data and the relevant equipment status data in the historical time period.

12. The industrial big data-based method according to claim 11, wherein in the industrial big data-based system, the data processing module comprises a preprocessing unit and a normalization unit;
the preprocessing unit is configured to perform preprocessing on the relevant data in the real-time dataset, wherein the preprocessing comprises the denoising, the missing value imputation, the outlier elimination, and data smoothing, and methods for the missing value imputation comprise mean imputation, median imputation, interpolation imputation, and regression imputation; and
the normalization unit is configured to eliminate, by using a dimensionless processing technology, a unit difference of relevant data in the preprocessed real-time dataset, such that a range of the relevant data in the preprocessed real-time dataset falls within [0, 1].

13. The industrial big data-based method according to claim 12, wherein in the industrial big data-based system, the startup priority analysis module comprises an operation status analysis unit, a priority unit, and a preliminary determination unit;
the operation status analysis unit is configured to extract the fuel consumption Rxz per unit time and the load output value Fsz of each unit from the relevant unit operation data in the processed real-time dataset, and calculate an economic index Jzb of each unit based on the fuel consumption Rxz per unit time and the load output value Fsz of each unit, wherein the economic index Jzb of each unit is specifically acquired according to a following formula:
$$Jzb = \frac{Rxz}{Fsz} ;$$
and
calculate a target power generation load value Fbz of each unit in different monitoring time periods based on the economic index Jzb of each unit and the load demand Dfyq of the power grid, wherein the target power generation load value Fbz of each unit in the different monitoring time periods is specifically acquired according to a following formula:
$$Fbz ( t ) = \frac{Dfyq ( t ) * {Jzb}^{- 1}}{{\sum }_{i = 1}^{n} {Jzb}^{- 1}}$$
wherein in the above formula, Fbz(t) represents a target power generation load value of the corresponding unit at a time point t, Dfyq(t) represents a load demand of the power grid at the time point t, Jzb⁻¹ represents an economic weight of the corresponding unit, n represents a quantity of units, and i=1, 2, 3, . . . , n.

14. The industrial big data-based method according to claim 13, wherein in the industrial big data-based system, the priority unit is configured to analyze and determine the current startup sequence of each unit based on the relevant unit operation data in the processed real-time dataset and a current load demand of the power grid, so as to acquire the unit startup priority Qyxj, wherein the unit startup priority Qyxj is specifically acquired according to a following formula:
$$Qyxj ( t ) = \frac{{Jzb}^{- 1} * Kyz ( t ) * {Fbz}_{max}}{Fbz ( t ) + ∈}$$
wherein in the above formula, Qyxj(t) represents a unit startup priority of the corresponding unit at the time point t, Kyz(t) represents an availability coefficient of the corresponding unit at the time point t, Fbzₘₐₓ represents the maximum target power generation load value of the corresponding unit, and E represents a correction constant.

15. The industrial big data-based method according to claim 14, wherein in the industrial big data-based system, the preliminary determination unit is configured to separately acquire the unit startup priority Qyxj for each unit according to a method of acquiring the unit startup priority Qyxj in the priority unit, and perform sorting to generate a sequence group; determine the unit startup priority Qyxj for the corresponding unit in the historical time period based on the historical dataset, and acquire an average unit startup priority Qyxj_{avg} of the corresponding unit by combining a statistical mean algorithm; and compare the unit startup priority Qyxj for a current unit with the average unit startup priority Qyxj_{avg} of the corresponding unit to determine a startup sequence and whether there is a fault risk for the corresponding unit, wherein preliminary determination content is specifically as follows:
in response to that the unit startup priority Qyxj for the current unit is greater than or equal to the average unit startup priority Qyxj_{avg} of the corresponding unit, preliminarily determining that there is no fault risk in the corresponding unit currently, such that the trend analysis instruction is not triggered temporarily, the corresponding unit is retained in the sequence group, and the corresponding unit is marked as a normal unit; or
in response to that the unit startup priority Qyxj for the current unit is less than the average unit startup priority Qyxj_{avg} of the corresponding unit, preliminarily determining that there is a fault risk in the corresponding unit, such that the trend analysis instruction is triggered, the corresponding unit is removed from the sequence group, and the corresponding unit is marked as an abnormal unit; and
count the normal unit based on the preliminary determination content, perform re-sorting to generate an optimized sequence group, and determine a startup sequence of each normal unit based on the optimized sequence group.

16. The industrial big data-based method according to claim 12, wherein in the industrial big data-based system, the fault identification module comprises a fault analysis unit and an identification unit;
the fault analysis unit is configured to, after receiving the trend analysis instruction, analyze the current fault evaluation index Ggzs_{c} of each current abnormal unit during the operation based on the relevant equipment status data in the processed real-time dataset after the dimensionless processing, wherein the current fault evaluation index Ggzs_{c} is acquired according to a following formula:
$${Ggzs}_{c} = \frac{Δ Qyxj * α + {Ybyz}_{1} * β + {Ybyz}_{2} * γ + Fbyz * φ}{α + β + γ + φ}$$
wherein in the above formula, ΔQyxj represents a unit startup priority difference, Ybyz₁ represents the boiler pressure fluctuation factor, Ybyz₂ represents the steam pipeline pressure fluctuation factor, Fbyz represents the unit load fluctuation factor, and α, β, γ, and φ all represent weight values, wherein 0<α<1, 0<β<1, 0<γ<1, 0<φ<1, and specific values of the α, the β, the γ, and the φ are set by a user based on a situation; and
the identification unit is configured to determine a time point in response to that a current corresponding abnormal unit is last marked as an abnormal unit to mark the time point as a start timestamp, and mark a current time point as an end timestamp; acquire a time interval based on the start timestamp and the end timestamp, and use the time interval as a comparison time period; extract a fault evaluation index Ggzsₕ at the start timestamp from the historical dataset based on the start timestamp; and compare the current fault evaluation index Ggzs_{c} of each unit during the operation with the fault evaluation index Ggzsₕ at the start timestamp to determine whether the corresponding abnormal unit needs to be maintained, wherein specific content is as follows:
in response to that the current fault evaluation index Ggzs_{c} of each unit during the operation exceeds the fault evaluation index Ggzsₕ at the start timestamp, a maintenance instruction is issued, and maintenance personnel is arranged to perform on-site maintenance; or
in response to that the current fault evaluation index Ggzs_{c} of each unit during the operation does not exceed the fault evaluation index Ggzsₕ at the start timestamp, no maintenance instruction is issued temporarily.

17. The industrial big data-based method according to claim 10, wherein in the industrial big data-based system, the effect feedback and optimization module comprises an effect feedback unit and an optimization unit;
the effect feedback unit is configured to: perform the feedback based on the actual effect formed by the startup sequence of each unit, and acquire the relevant feedback data, wherein the relevant feedback data comprises a quantity m of normal units, a load output value of a corresponding normal unit at each time point, a target power generation load value of the corresponding normal unit at each time point, and a fuel consumption of the corresponding normal unit at each time point; and evaluate the balance effect between the response capability of the power grid load and the unit operation efficiency based on the relevant feedback data, and perform the dimensionless processing to construct the performance feedback index Xfzs, wherein the performance feedback index Xfzs is acquired according to a following formula:
$$Xfzs ( t ) = {\sum }_{k = 1}^{m} \vert {Fsz}_{k} ( t ) - {Fbz}_{k} ( t ) \vert + ω * {\sum }_{k = 1}^{m} ( \frac{{Rxz}_{k} ( t )}{{Fsz}_{k} ( t )} )$$
wherein in the above formula, k=1, 2, . . . , m, m represents the quantity of normal units, Xfzs(t) represents a performance feedback index at a time point t, Fszₖ(t) represents a load output value of a k^{th} normal unit at the time point t, Fbzₖ(t) represents a target power generation load value of the k^{th} normal unit at the time point t, Rxzₖ(t) represents a fuel consumption of the k^{th} normal unit at the time point t, and w represents a weight coefficient.

18. The industrial big data-based method according to claim 17, wherein in the industrial big data-based system, the optimization unit is configured to adjust and optimize the load capacity of the corresponding unit based on the performance feedback index Xfzs by using a gradient descent method, so as to acquire a load adjustment amount Ft of the corresponding unit at each subsequent time point:
$$Ft ( t ) = - η * \frac{ϑ Xfzs ( t )}{ϑ {Fsz}_{k} ( t )}$$
wherein in the above formula, Xfzs(t) represents the performance feedback index at the time point t, η represents a learning rate, and
$$\frac{ϑ Xfzs ( t )}{ϑ {Fsz}_{k} ( t )}$$
represents a partial derivative of the performance feedback index at the time point t with respect to the load output value of the unit at the time point t.
